(19) United States
(12) Patent Application Publication
(10) Pub. No.: US 2020/0156420 A1
(43) Pub. Date: May 21, 2020

(54) PUNCTURE RESISTANT TUBE

(71) Applicant: Bridgestone Americas Tire Operations, LLC, Nashville, TN (US)

(72) Inventors: David J. Zemla, Canal Fulton, OH (US); James M. Kirby, Akron, OH (US)

(21) Appl. No.: 16/631,857

(22) PCT Filed: Jul. 11, 2018
(86) PCT No.: PCT/US18/41605

§ 371 Date: Jan. 17, 2020

Related U.S. Application Data
(60) Provisional application No. 62/534,718, filed on Jul. 20, 2017.

(51) Int. Cl. B60C 19/12; B60C 5/08

(52) U.S. Cl. CPC B60C 19/127; B60C 5/08

(57) ABSTRACT

An inner tube for a pneumatic tire having an increased resistance to punctures. The inner tube may have at least one puncture resistant ply made from a fiber reinforcement oriented around the outer circumference of the inner tube. The inner tube may provide increased resistance to punctures in the tread portion of the tire.

### BACKGROUND

Since the introduction of the pneumatic tire, there has been a need for a pneumatic tire that is resistant to punctures. Accordingly, various materials and constructions have been proposed, with varying degrees of success. One of the challenges that has made it difficult to solve this problem is finding an adequate balance between puncture resistance, rolling resistance, weight, stiffness, flexibility, and durability.

For example, materials that provide adequate puncture resistance may be too heavy or too stiff and result in a tire having insufficient rolling resistance or durability. By contrast, materials that provide adequate rolling resistance and durability may have insufficient puncture resistance.

One solution is to provide an inner tube inside of a pneumatic tire such that the inner tube may contain the pressurized air while the tire may provide structural support. Separating these functions into individual structures may allow for a wider range of specialized material selections for each structure.

For example, an inner tube may be made from materials that provide for excellent air retention without the need to provide load carrying support. Likewise, a tire may be made from materials that provide excellent load carrying support without the need to provide air retention.

When a pneumatic tire is designed to provide load carrying support and provide for air retention, such as a pneumatic tire having a butyl inner liner, a puncture of the tire may lead to air loss. However, when a pneumatic tire utilizes an inner tube, rather than an inner liner, to contain the pressurized air, a puncture of the tire may not necessarily lead to air loss. Instead, the inner tube may need to be punctured before the tire loses air.

Another solution is to provide an inner tube with a reinforcement layer to provide puncture resistance. The reinforcement layer providing puncture resistance may be selected solely for the purpose of preventing punctures. However, the reinforcement layer may also be selected to provide radial or circumferential reinforcement.

For example, a tire may also have a carcass made from body plies that provide radial support. The tire may also have a belt made from belt plies that provide circumferential support. An inner tube for use with the tire may include a reinforcement layer made from materials that primarily provide puncture resistance. Optionally, the body plies and/or the belt plies may be made from materials that, in addition to their primary functions of providing for radial reinforcement and circumferential reinforcement, respectively, also provide resistance to punctures.

What is needed is an inner tube, a pneumatic tire, or a combination thereof that adequately balances puncture resistance with rolling resistance, weight, stiffness, flexibility, and durability.

### SUMMARY

In one embodiment, an inner tube for a pneumatic tire may have a substantially airtight and flexible toroidal tube having an axial width TW. The tube may have a cross-section that may be either circular or elliptical when inflated. The tube may have a centerline TC oriented circumferentially on a radially outer surface of the tube. The tube may have a substantially puncture-resistant and flexible liner having a first edge and a second edge. The liner may be formed in a continuous loop and may be operatively connected to the radially outer surface of the tube. A distance D1 measured from the centerline TC of the tube to the first edge of the liner may be between about 10% and about 50% of the axial width TW of the tube. A distance D2 measured from the centerline TC of the tube to the second edge of the liner may be between about 10% and about 50% of the axial width TW of the tube. The liner may have a fiber reinforcement comprising a fiber having a weight greater than 15 denier.

In another embodiment, an inner tube for a pneumatic tire may have a substantially airtight and flexible toroidal tube having an axial width TW. The tube may have a cross-section that may be either circular or elliptical when inflated. The tube may have a centerline TC oriented circumferentially on a radially outer surface of the tube. The tube may have a substantially puncture-resistant and flexible liner having an axial width LW. The liner may be formed in a continuous loop and may be operatively connected to the radially outer surface of the tube. The axial width LW of the liner may be at least one of: between about 15% and about 40% of the circumference of the tube when the tube is uninflated, and between about 15% and about 35% of the circumference of the tube when the tube is inflated. The liner may have a fiber reinforcement comprising a fiber having a weight greater than 15 denier.

In another embodiment, a wheel system may have a wheel and a pneumatic tire mounted to the wheel. The tire may have a tread portion oriented axially between a first shoulder portion and a second shoulder portion. An inner tube may be installed within a cavity formed between a radially outer surface of the wheel and a radially inner surface of the tire. The inner tube may have a substantially airtight and flexible toroidal tube having a cross-section that may be either circular or elliptical when inflated. The wheel system may have a substantially puncture-resistant and flexible liner formed in a continuous loop and operatively connected to a radially outer surface of the tube. The liner may be oriented radially inward of the tread portion and axially between the first shoulder portion and the second shoulder portion. The liner may have a fiber reinforcement comprising a fiber having a weight greater than 15 denier.

### BRIEF DESCRIPTION OF THE DRAWINGS

The accompanying figures, which are incorporated in and constitute a part of the specification, illustrate various example embodiments, and are used merely to illustrate various example embodiments. In the figures, like elements bear like reference numerals.

FIG. 1 illustrates a perspective view of a prior art inner tube.

FIG. 2 illustrates a perspective view of a puncture resistant liner for an inner tube.

FIG. 3 illustrates a perspective view of a puncture resistant liner operatively connected to an inner tube.

FIG. 4 illustrates a sectional view of a puncture resistant liner operatively connected to an inner tube.

FIG. 5 illustrates a sectional view of a puncture resistant liner operatively connected to an inner tube, which is oriented in a cavity of a pneumatic tire.

### DETAILED DESCRIPTION

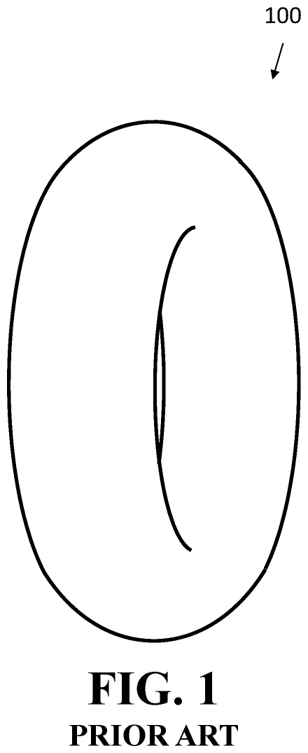

FIG. 1 illustrates a perspective view of an example prior art arrangement of an inner tube 100. Inner tube 100 may be a substantially airtight and flexible toroidal tube. Inner tube 100 may comprise a material that provides for air retention. Examples of such materials include butyl rubber and latex rubber.

Inner tube 100 may be installed in a cavity of a tire (not shown) that is mounted on a wheel (not shown). The tire may provide for load carrying support. The tire may further provide for traction. Inner tube 100, the tire, and the wheel may form a wheel system. The wheel system may be mounted on a vehicle (not shown).

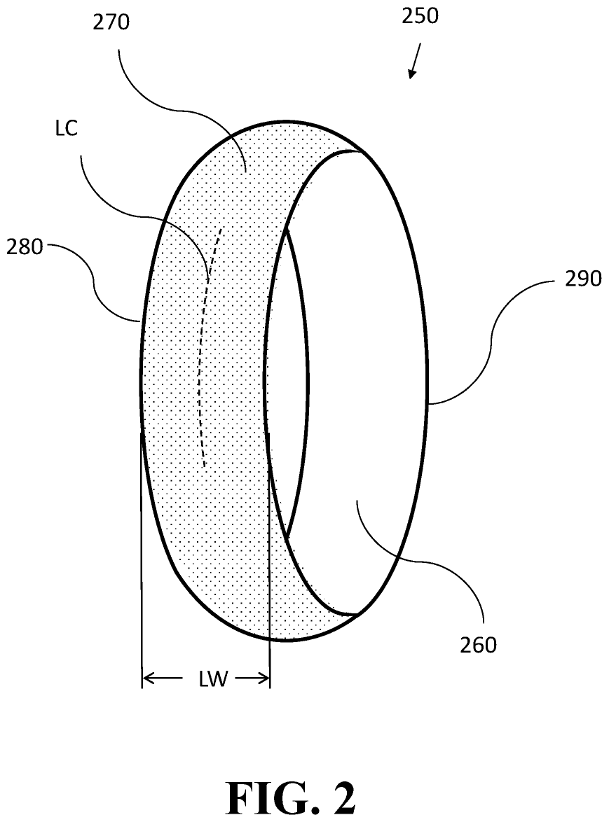

FIG. 2 illustrates a perspective view of a liner 250. Liner 250 may be a liner for a pneumatic tire (not shown). Liner 250 may be a liner for a pneumatic tire that requires an inner tube (not shown) to contain pressurized air in a tire cavity. Liner 250 may be a liner for a pneumatic tire that has an inner liner to contain pressurized air in the tire cavity. Liner 250 may be a liner for a pneumatic tire that has an inner tube and an inner liner.

Liner 250 may be a flexible liner. Liner 250 may be a puncture resistant liner. Liner 250 may be a puncture resistant and flexible liner. Liner 250 may be a substantially puncture resistant and flexible liner.

In one embodiment, liner 250 may be formed as a rectangle (not shown). Liner 250 may be formed into a loop by abutting or overlapping opposing ends of the rectangle. The abutting or overlapping opposing ends of the rectangle may be attached or unattached to one another. The rectangle may have a width corresponding to an axial width LW of liner 250. The rectangle may have a width that is greater than axial width LW to take into account the curvature of liner 250. The rectangle may have a length corresponding to the circumference of liner 250. The rectangle may have a length that is greater than the circumference of liner 250 in order to allow the opposing ends of liner 250 to overlap when formed into a loop.

In one embodiment, liner 250 may be formed as a continuous loop. Liner 250 may have radially opposing surfaces. Liner 250 may have a radially inner surface 260 and a radially outer surface 270. Liner 250 may have axially opposing edges. Liner 250 may have a first edge 280 and a second edge 290. Liner 250 may have a centerline LC on the radial outer surface and/or on the radial inner surface of liner 250 such that centerline LC is spaced an equal distance from each of first edge 280 and second edge 290.

Liner 250 may be made from a fiber reinforcement. The fiber reinforcement may be at least one of: a unidirectional fabric, a woven fabric, and a knitted fabric. The fiber reinforcement may have any orientation of fibers that provides for a mesh structure that allows for both open space and movement among adjacent fibers. The fiber reinforcement may be selected for at least one of: its strength, its durability, its flexibility, its weight, its density, its adhesion to other materials, its puncture resistance, and the like.

The puncture resistance of liner 250 may be provided by a fiber reinforcement having a mesh structure of adjacent fibers that are sufficiently close to one another so as to prevent a foreign object from penetrating the mesh structure. The flexibility of liner 250 may be provided by a fiber reinforcement having a mesh structure of adjacent fibers that are sufficiently free to allow movement among one another.

The fiber reinforcement of liner 250 may be used to reinforce another material, such as a polymer. Suitable polymers may include elastomers, such as but not limited to, natural rubbers, synthetic rubbers, and thermoplastic elastomers. The material reinforced by the fiber reinforcement is not limited and may be selected from any material depending upon the needs of the application in accordance with contemporary design, engineering, materials science principles, and the like. The fiber reinforcement may be used to reinforce any material suitable for use in an inner tube or in a tire.

The adhesion of the fiber reinforcement to the material it reinforces may be promoted by allowing sufficient space between adjacent fibers of the mesh structure for the material to penetrate. For example, a polymer may adhere better to a mesh structure having larger spaces between adjacent fibers than the polymer may adhere to a mesh structure having smaller spaces between adjacent fibers.

Liner 250 may require an ideal balance between adhesion to a material, such as a polymer, and puncture resistance. For example, if the adjacent fibers of the mesh structure are too close together, a material may adhere poorly to the mesh structure because the material may be unable to penetrate into the small spaces between adjacent fibers. However, such an arrangement may provide for excellent puncture resistance because the close proximity of the adjacent fibers of the mesh structure may prevent objects from penetrating the mesh structure. By contrast, if the adjacent fibers of the mesh structure are farther apart, a material may have excellent adherence to the mesh structure because the material may be able to sufficiently penetrate into the larger spaces between adjacent fibers. However, such an arrangement may provide for poor puncture resistance because the larger spaces between the adjacent fibers of the mesh structure may allow objects to penetrate the mesh structure.

In one embodiment, liner 250 may be a substantially puncture resistant and flexible liner. Liner 250 may be made from a fiber reinforcement selected for its flexibility and/or its puncture resistance. Liner 250 may be made from a fiber reinforcement having a mesh structure that is sufficiently open to allow the material it reinforces to properly adhere to the mesh structure, while simultaneously being sufficiently closed to prevent objects from penetrating the mesh structure.

In one embodiment, liner 250 may include a fiber reinforcement comprising a fiber having a weight greater than 15 (or about 15) denier. Liner 250 may include a fiber reinforcement comprising a fiber having a weight between 500 (or about 500) denier and 1500 (or about 1500) denier. Liner 250 may include a fiber reinforcement comprising a fiber having a weight between 700 (or about 700) denier and 1200 (or about 1200) denier. Liner 250 may include a fiber reinforcement comprising a fiber having a weight between 840 (or about 840) denier and 1050 (or about 1050) denier. Liner 250 may include a fiber reinforcement comprising a fiber having a weight of at least one of: 840 (or about 840) denier and 1050 (or about 1050) denier.

Liner 250 may include a fiber reinforcement comprising a nylon fiber. Liner 250 may include a fiber reinforcement comprising nylon 66. Liner 250 may include a fiber reinforcement comprising an aramid fiber. Liner 250 may include a fiber reinforcement comprising a synthetic fiber. Liner 250 may include a fiber reinforcement comprising a natural fiber. Liner 250 may include a fiber reinforcement comprising a monofilament fiber. Liner 250 may include a fiber reinforcement comprising a multifilament fiber. Liner 250 may include a combination of fiber types as discussed above.

Liner 250 may include a fiber reinforcement comprising a nylon fiber having a weight between 700 (or about 700) denier and 1200 (or about 1200) denier. Liner 250 may include a fiber reinforcement comprising a nylon fiber having a weight of 840 (or about 840) denier. Liner 250 may include a fiber reinforcement comprising a nylon fiber having a weight of 1050 (or about 1050) denier. The fiber reinforcement may be made from a nylon fiber that is knitted and has both warp and fill weights of 840 (or about 840) denier. The fiber reinforcement may be made from a nylon fiber that is knitted and has both warp and fill weights of 1050 (or about 1050) denier. The fiber reinforcement may be made from a nylon fiber that is knitted and has a warp weight of 840 (or about 840) denier and has a fill weight of 1050 (or about 1050) denier. The fiber reinforcement may be made from a nylon fiber that is knitted and has a warp weight of 1050 (or about 1050) denier and has a fill weight of 840 (or about 840) denier.

Liner 250 may include a fiber reinforcement having between 20 (or about 20) ends per inch and 25 (or about 25) ends per inch (7.5 (or about 7.5) ends per cm. and 10.0 (or about 10.0) ends per cm.). The fiber reinforcement may have between 21 (or about 21) ends per inch and 23 (or about 23) ends per inch (8.0 (or about 8.0) ends per cm. and 9.5 (or about 9.5) ends per cm.). The fiber reinforcement may have 21 (or about 21) ends per inch (8.0 (or about 8.0) ends per cm.). The fiber reinforcement may have 22 (or about 22) ends per inch (8.5 (or about 8.5) ends per cm.). The fiber reinforcement may have 23 (or about 23) ends per inch (9.5 (or about 9.5) ends per cm.).

Liner 250 may include a fiber reinforcement having between 35 (or about 35) ends per inch and 45 (or about 45) ends per inch (13.5 (or about 13.5) ends per cm. and 18.0 (or about 18.0) ends per cm.). The fiber reinforcement may have between 39 (or about 39) ends per inch and 41 (or about 41) ends per inch (15.0 (or about 15.0) ends per cm. and 16.5 (or about 16.5) ends per cm.). The fiber reinforcement may have 39 (or about 39) ends per inch (15.0 (or about 15.0) ends per cm.). The fiber reinforcement may have 40 (or about 40) ends per inch (15.5 (or about 15.5) ends per cm.). The fiber reinforcement may have 41 (or about 41) ends per inch (16.5 (or about 16.5) ends per cm.).

Liner 250 may include a fiber reinforcement having between 15 (or about 15) picks per inch and 20 (or about 20) picks per inch (5.5 (or about 5.5) picks per cm. and 7.5 (or about 7.5) picks per cm.). The fiber reinforcement may have between 16 (or about 16) picks per inch and 18 (or about 18) picks per inch (6.0 (or about 6.0) picks per cm. and 7.0 (or about 7.0) picks per cm.). The fiber reinforcement may have 16 (or about 16) picks per inch (6.0 (or about 6.0) picks per cm.). The fiber reinforcement may have 17 (or about 17) picks per inch (6.5 (or about 6.5) picks per cm.). The fiber reinforcement may have 18 (or about 18) picks per inch (7.0 (or about 7.0) picks per cm.).

Liner 250 may include a fiber reinforcement having between 35 (or about 35) picks per inch and 45 (or about 45) picks per inch (13.5 (or about 13.5) picks per cm. and 18.0 (or about 18.0) picks per cm.). The fiber reinforcement may have between 39 (or about 39) picks per inch and 41 (or about 41) picks per inch (15.0 (or about 15.0) picks per cm. and 16.5 (or about 16.5) picks per cm.). The fiber reinforcement may have 39 (or about 39) picks per inch (15.0 (or about 15.0) picks per cm.). The fiber reinforcement may have 40 (or about 40) picks per inch (15.5 (or about 15.5) picks per cm.). The fiber reinforcement may have 41 (or about 41) picks per inch (16.5 (or about 16.5) picks per cm.).

Liner 250 may include a fiber reinforcement comprising a fiber having a gauge between 0.010 (or about 0.010) inch and 0.020 (or about 0.020) inch (0.25 (or about 0.25) mm and 0.51 (or about 0.51) mm) The fiber reinforcement may be made from a fiber having a gauge between 0.014 (or about 0.014) inch and 0.018 (or about 0.018) inch (0.35 (or about 0.35) mm and 0.46 (or about 0.46) mm) The fiber reinforcement may be made from a fiber having a gauge of 0.014 (or about 0.014) inch (0.35 (or about 0.35) mm) The fiber reinforcement may be made from a fiber having a gauge of 0.016 (or about 0.016) inch (0.41 (or about 0.41) mm) The fiber reinforcement may be made from a fiber having a gauge of 0.018 (or about 0.018) inch (0.46 (or about 0.46) mm.).

Liner 250 may include a fiber reinforcement comprising a fiber having a gauge between 0.025 (or about 0.025) inch and 0.035 (or about 0.035) inch (0.63 (or about 0.63) mm and 0.89 (or about 0.89) mm) The fiber reinforcement may be made from a fiber having a gauge between 0.027 (or about 0.027) inch and 0.031 (or about 0.031) inch (0.68 (or about 0.68) mm and 0.79 (or about 0.79) mm) The fiber reinforcement may be made from a fiber having a gauge of 0.027 (or about 0.027) inch (0.68 (or about 0.68) mm) The fiber reinforcement may be made from a fiber having a gauge of 0.029 (or about 0.029) inch (0.74 (or about 0.74) mm) The fiber reinforcement may be made from a fiber having a gauge of 0.031 (or about 0.031) inch (0.79 (or about 0.79) mm.).

Liner 250 may include a fiber reinforcement having a maximum shrinkage of between 1.0% (or about 1.0%) and 3.0% (or about 3.0%). The fiber reinforcement may have a maximum shrinkage of between 1.5% (or about 1.5%) and 2.5% (or about 2.5%). The fiber reinforcement may have a maximum shrinkage of 2.5% (or about 2.5%). The fiber reinforcement may have a maximum shrinkage max of 1.5% (or about 1.5%).

Liner 250 may include a fiber reinforcement having a weight per sq. yd. of 4.0 (or about 4.0) oz. to 6.0 (or about 6.0) oz. (weight per sq. m. of 135 (or about 135) g. to 204 (or about 204) g.). The fiber reinforcement may have a weight per sq. yd. of 4.9 (or about 4.9) oz. to 5.3 (or about 5.3) oz. (weight per sq. m. of 166 (or about 166) g. to 180 (or about 180) g.). The fiber reinforcement may have a weight per sq. yd. of 4.9 (or about 4.9) oz. (weight per sq. m. of 166 (or about 166) g.). The fiber reinforcement may have a weight per sq. yd. of 5.1 (or about 5.1) oz. (weight per sq. m. of 173 (or about 173) g.). The fiber reinforcement may have a weight per sq. yd. of 5.3 (or about 5.3) oz. (weight per sq. m. of 180 (or about 180) g.).

Liner 250 may include a fiber reinforcement having a weight per sq. yd. of 10.0 (or about 10.0) oz. to 15.0 (or about 15.0) oz. (weight per sq. m. of 339 (or about 339) g. to 509 (or about 509) g.). The fiber reinforcement may have a weight per sq. yd. of 11.7 (or about 11.7) oz. to 12.4 (or about 12.4) oz. (weight per sq. m. of 397 (or about 397) g. to 420 (or about 420) g.). The fiber reinforcement may have a weight per sq. yd. of 11.7 (or about 11.7) oz. (weight per sq. m. of 397 (or about 397) g.). The fiber reinforcement may have a weight per sq. yd. of 12.05 (or about 12.05) oz. (weight per sq. m. of 409 (or about 409) g.). The fiber reinforcement may have a weight per sq. yd. of 12.4 (or about 12.4) oz. (weight per sq. m. of 420 (or about 420) g.).

Liner 250 may include a fabric reinforcement having a minimum tensile strength in both the warp and the fill directions of greater than 300 (or about 300) lbf (1334 (or about 1334) N). The fabric reinforcement may have a minimum tensile strength in both the warp and the fill directions of greater than 400 (or about 400) lbf (1779 (or about 1779) N). The fabric reinforcement may have a minimum tensile strength in both the warp and the fill directions of greater than 500 (or about 500) lbf (2224 (or about 2224) N). The fabric reinforcement may have a minimum tensile strength in both the warp and the fill directions of greater than 600 (or about 600) lbf (2669 (or about 2669) N). The fabric reinforcement may have a minimum tensile strength in at least one of the warp direction and the fill direction of 375 (or about 375) lbf (1668 (or about 1668) N). The fabric reinforcement may have a minimum tensile strength in at least one of the warp direction and the fill direction of 400 (or about 400) lbf (1779 (or about 1779) N). The fabric reinforcement may have a minimum tensile strength in at least one of the warp direction and the fill direction of 650 (or about 650) lbf (2891 (or about 2891) N).

Liner 250 may include a fabric reinforcement having a minimum warp adhesion of greater than 10 (or about 10) lbf (44 (or about 44) N). The fabric reinforcement may have a minimum warp adhesion of 15 (or about 15) lbf (67 (or about 67) N).

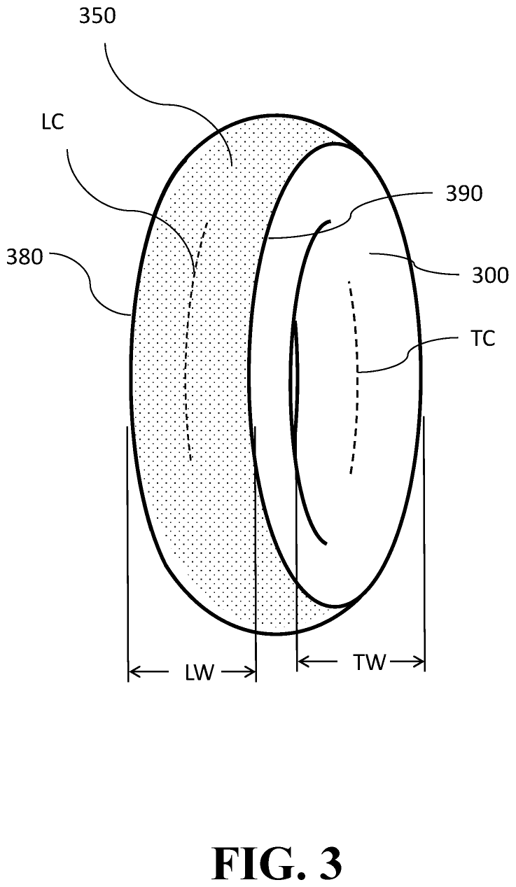

FIG. 3 illustrates a perspective view of an inner tube 300 and a liner 350. Inner tube 300 may have an inner surface (radially inner) and an outer surface (radially outer). Inner tube 300 may have a toroidal shape. Inner tube 300 may have an axial tube width TW. Inner tube 300 may have a cross section that is either circular or elliptical when inner tube 300 is inflated. Inner tube 300 may have a centerline TC oriented on the radial outer surface of inner tube 300. Centerline TC may be centered on the radial outer surface of inner tube 300 such that centerline TC is spaced an equal distance from each of a first axial edge (not shown) and a second axial edge (not shown) of inner tube 300.

Liner 350 may be a flexible liner. Liner 350 may be a puncture resistant liner. Liner 350 may be a puncture resistant and flexible liner. Liner 350 may be a substantially puncture resistant and flexible liner.

Liner 350 may be made from a fiber reinforcement. The fiber reinforcement may be at least one of: a unidirectional fabric, a woven fabric, and a knitted fabric. The fiber reinforcement may have any orientation of fibers that provides for a mesh structure that allows for both open space and movement among adjacent fibers. The fiber reinforcement may be selected for at least one of: its strength, its durability, its flexibility, its weight, its density, its adhesion to other materials, its puncture resistance, and the like.

The puncture resistance of liner 350 may be provided by a fiber reinforcement having a mesh structure of adjacent fibers that are sufficiently close to one another so as to prevent a foreign object from penetrating the mesh structure. The flexibility of liner 350 may be provided by a fiber reinforcement having a mesh structure of adjacent fibers that are sufficiently free to allow movement among one another.

The fiber reinforcement of liner 350 may be used to reinforce another material, such as a polymer. Suitable polymers may include elastomers, such as but not limited to, natural rubbers, synthetic rubbers, and thermoplastic elastomers. The material reinforced by the fiber reinforcement is not limited and may be selected from any material depending upon the needs of the application in accordance with contemporary design, engineering, materials science principles, and the like. The fiber reinforcement may be used to reinforce any material suitable for use in an inner tube or in a tire.

Liner 350 may be a substantially puncture resistant and flexible liner. Liner 350 may be made from a fiber reinforcement selected for its flexibility and/or its puncture resistance. Liner 350 may be made from a fiber reinforcement having a mesh structure that is sufficiently open to allow the material it reinforces to properly adhere to the mesh structure, while simultaneously being sufficiently closed to prevent objects from penetrating the mesh structure.

Liner 350 may have the same material properties, including warp adhesion, weight, material type, ends per in./cm., picks per in./cm., fiber gauge, shrinkage, weight/mass per area, and tensile strength, as liner 250 described above with respect to FIG. 2.

Liner 350 may have opposing radial surfaces. Liner 350 may have a radially inner surface and a radially outer surface. Liner 350 may have opposing axial edges. Liner 350 may have a first edge 380 and a second edge 390. Liner 350 may have a centerline LC on the radial outer surface and/or on the radial inner surface of liner 350 such that centerline LC is spaced an equal distance from each of first edge 380 and second edge 390.

Inner tube 300 may be an inner tube for a vehicle (not shown). Inner tube 300 may be an inner tube for a pneumatic tire (not shown). Inner tube 300 may be an inner tube for any number of vehicles, including but not limited to, a passenger car, a light truck, a bus, a truck, an agricultural vehicle, an off-road vehicle, a motorcycle, and the like. Inner tube 300 may be an inner tube for a trailer (not shown).

Inner tube 300 may be an airtight inner tube configured to contain pressurized air. Inner tube 300 may be a substantially airtight inner tube. Inner tube 300 may have a valve (not shown) configured to allow air to be pumped into inner tube 300. The valve may be configured to prevent air inside inner tube 300 from escaping unless operated by a person to allow the valve to release the air.

Inner tube 300 may be a flexible inner tube. Inner tube 300 may comprise a polymer, a blend of polymers, and other materials. For example, inner tube 300 may comprise, without limitation, a natural rubber and/or a synthetic rubber. Inner tube 300 may comprise a butyl rubber. Inner tube 300 may comprise a latex rubber. Inner tube 300 may comprise a thermoplastic polymer. Inner tube 300 may comprise any flexible material, or any flexible blend of materials, capable of containing pressurized air.

Liner 350 may be formed as a loop circumferentially around the radially outer surface of inner tube 300. Liner 350 may be formed as a rectangle. The opposing ends of liner 350 may abut or overlap to form a loop around the radially outer surface of inner tube 300. Liner 350 may be formed as a continuous loop around the radially outer surface of inner tube 300.

Centerline LC of liner 350 may be offset from centerline TC of inner tube 300. In one embodiment, centerline LC of liner 350 and centerline TC of inner tube 300 may be in about the same radial plane. In one embodiment, centerline LC of liner 350 and centerline TC of inner tube 300 may be in substantially the same radial plane. In one embodiment, centerline LC of liner 350 and centerline TC of inner tube 300 may be in precisely the same radial plane.

The radially inner surface of liner 350 may be operatively connected to the radially outer surface of inner tube 300. Liner 350 may be operatively connected to inner tube 300 so as to minimize relative movement between liner 350 and inner tube 300. Liner 350 may be operatively connected to inner tube 300 so as to substantially prevent relative movement between liner 350 and inner tube 300. Liner 350 may be operatively connected to inner tube 300 so as to prohibit relative movement between liner 350 and inner tube 300. Liner 350 may be operatively connected to inner tube 300 by at least one of: an adhesive composition, a double-sided adhesive tape, a vulcanization bond, and an interference fit.

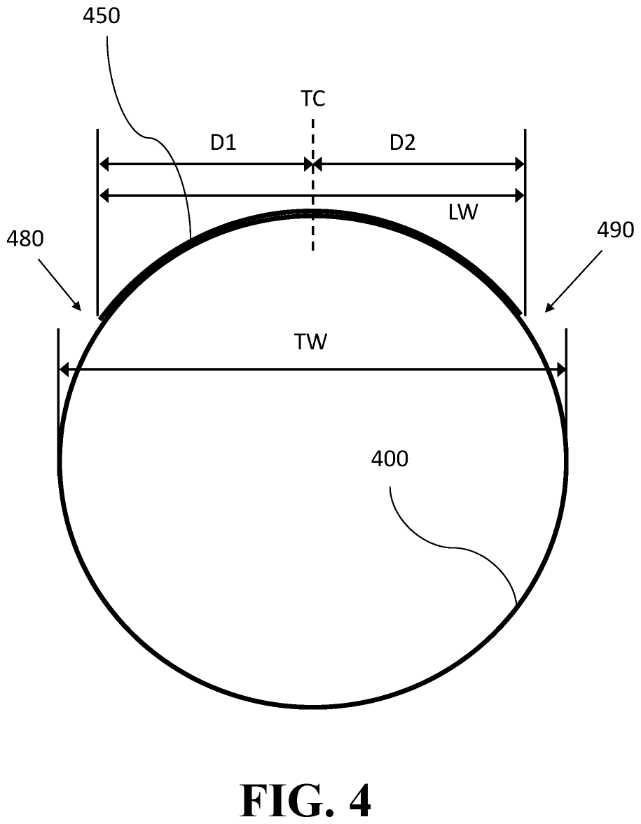

FIG. 4 illustrates a sectional view of an inner tube 400 and a liner 450. Inner tube 400 may have an inner surface and an outer surface. Inner tube 400 may have a toroidal shape. Inner tube 400 may have an axial tube width TW. Inner tube 400 may have a cross section that is either circular or elliptical when inner tube 400 is inflated. Inner tube 400 may have a centerline TC oriented on the radial outer surface of inner tube 400. Centerline TC may be centered on the radial outer surface of inner tube 400 such that centerline TC is spaced an equal distance from each of a first axial edge (not shown) and a second axial edge (not shown) of inner tube 400.

Liner 450 may be a flexible liner. Liner 450 may be a puncture resistant liner. Liner 450 may be a puncture resistant and flexible liner. Liner 450 may be a substantially puncture resistant and flexible liner.

Liner 450 may be formed as a rectangle (not shown). The rectangle may have a width corresponding to an axial width LW of liner 450. The rectangle may have a width greater than an axial width LW of liner 450 to account for the curvature of liner 450. The rectangle may have a length corresponding to the circumference of liner 450. The rectangle may have a length that is greater than the circumference of liner 450 in order to allow the opposing ends of liner 450 to overlap when formed into a loop.

Liner 450 may be formed as a continuous loop. Liner 450 may have radially opposing surfaces. Liner 450 may have a radially inner surface (not shown) and a radially outer surface (not shown). Liner 450 may have a centerline LC (not shown) on the radial outer surface and/or on the radial inner surface of liner 450 such that centerline LC is spaced an equal distance from each of first edge 480 and second edge 490.

Liner 450 may be made from a fiber reinforcement. The fiber reinforcement may be at least one of: a unidirectional fabric, a woven fabric, and a knitted fabric. The fiber reinforcement may have any orientation of fibers that provides for a mesh structure that allows for both open space and movement among adjacent fibers. The fiber reinforcement may be selected for at least one of: its strength, its durability, its flexibility, its weight, its density, its adhesion to other materials, its puncture resistance, and the like.

The puncture resistance of liner 450 may be provided by a fiber reinforcement having a mesh structure of adjacent fibers that are sufficiently close to one another so as to prevent a foreign object from penetrating the mesh structure. The flexibility of liner 450 may be provided by a fiber reinforcement having a mesh structure of adjacent fibers that are sufficiently free to allow movement among one another.

The fiber reinforcement of liner 450 may be used to reinforce another material, such as a polymer. Suitable polymers may include elastomers, such as but not limited to, natural rubbers, synthetic rubbers, and thermoplastic elastomers. The material reinforced by the fiber reinforcement is not limited and may be selected from any material depending upon the needs of the application in accordance with contemporary design, engineering, materials science principles, and the like. The fiber reinforcement may be used to reinforce any material suitable for use in an inner tube or in a tire.

Liner 450 may be a substantially puncture resistant and flexible liner. Liner 450 may be made from a fiber reinforcement selected for its flexibility and/or its puncture resistance. Liner 450 may be made from a fiber reinforcement having a mesh structure that is sufficiently open to allow the material it reinforces to properly adhere to the mesh structure, while simultaneously being sufficiently closed to prevent objects from penetrating the mesh structure.

Liner 450 may have the same material properties, including warp adhesion, weight, material type, ends per in./cm., picks per in./cm., fiber gauge, shrinkage, weight/mass per area, and tensile strength, as liner 250 described above with respect to FIG. 2.

The radially inner surface of liner 450 may be operatively connected to the radially outer surface of inner tube 400. In one embodiment, inner tube 400 may have an axial width TW and an axial centerline TC located at an axial midpoint of width TW. Liner 450 may have an axial width LW and an axial centerline LC (not shown) located at an axial midpoint of width LW.

Liner 450 may provide for puncture resistance of inner tube 400 in the area of inner tube 400 that is covered by liner 450. The position of liner 450 relative to inner tube 400 may be modified so as to control the area of inner tube 400 in which puncture resistance is required. For example, puncture resistance may be required in the area of inner tube 400 that is radially inward of a tread portion (not shown) of a tire (not shown). Accordingly, liner 450 may be positioned on inner tube 400 such that liner 450 extends axially between the shoulder portions (not shown) of the tire. Likewise, puncture resistance may be required in the areas inner tube 400 that are radially and/or axially inward of the shoulder portion and/or a sidewall portion of the tire.

However, in some cases, it may be important to have puncture resistance in the area of inner tube 400 that is radially inward of the tread portion, and it may be equally important to provide no puncture resistance in the areas of inner tube 400 that are radially and/or axially inward of the shoulder portion and/or the sidewall portion. For example, it may be possible to safely repair a puncture located in a tread portion because the construction of the tire in the tread portion may be less likely to lead to a catastrophic failure of the tire than when punctures occur in other locations of the tire. Consequently, it may not be possible to safely repair a puncture located in the shoulder portion or the sidewall portion of a tire because such punctures may be more likely to lead to a catastrophic failure of the tire. A catastrophic failure of the tire may be dangerous to an occupant of a vehicle (not shown), as well as to nearby pedestrians and to occupants of nearby vehicles. Thus, in one embodiment, liner 450 may be positioned on inner tube 400 so as to provide puncture resistance only in the area of inner tube 400 that is radially inward of the tread portion. In one embodiment, liner 450 may not extend into the areas of inner tube 400 that are radially inward and/or axially inward of the shoulder portions or the sidewall portions of the tire.

Liner 450 may be positioned on inner tube 400 such that a distance D1 may be measured from centerline TC of inner tube 400 to first edge 480 of liner 450. Liner 450 may be positioned on inner tube 400 such that a distance D2 may be measured from centerline TC of inner tube 400 to second edge 490 of liner 450. Distance D1 may measure from 10 (or about 10) % to 50 (or about 50) % of width TW of inner tube 400. Distance D1 may measure from 20 (or about 20) % to 45 (or about 45) % of width TW of inner tube 400. Distance D1 may measure from 30 (or about 30) % to 40 (or about 40) % of width TW of inner tube 400. Distance D2 may measure from 10 (or about 10) % to 50 (or about 50) % of width TW of inner tube 400. Distance D2 may measure from 20 (or about 20) % to 45 (or about 45) % of width TW of inner tube 400. Distance D2 may measure from 30 (or about 30) % to 40 (or about 40) % of width TW of inner tube 400.

In one embodiment, distance D1 is greater than distance D2. In one embodiment, distance D1 is less than distance D2. In one embodiment, distance D1 and distance D2 are substantially equal. In one embodiment, distance D1 and distance D2 are precisely equal.

Width LW of liner 450 may measure from 15 (or about 15) % to 40 (or about 40) % of a circumference of inner tube 400 when inner tube 400 is uninflated. Width LW of liner 450 may measure from 20 (or about 20) % to 35 (or about 35) % of the circumference of inner tube 400 when inner tube 400 is uninflated. Width LW of liner 450 may measure from 25 (or about 25) % to 35 (or about 35) % of the circumference of inner tube 400 when inner tube 400 is uninflated.

Width LW of liner 450 may measure from 15 (or about 15) % to 35 (or about 35) % of a circumference of inner tube 400 when inner tube 400 is inflated. Width LW of liner 450 may measure from 20 (or about 20) % to 30 (or about 30) % of the circumference of inner tube 400 when inner tube 400 is inflated. Width LW of liner 450 may measure from 25 (or about 25) % to 30 (or about 30) % of the circumference of inner tube 400 when inner tube 400 is inflated.

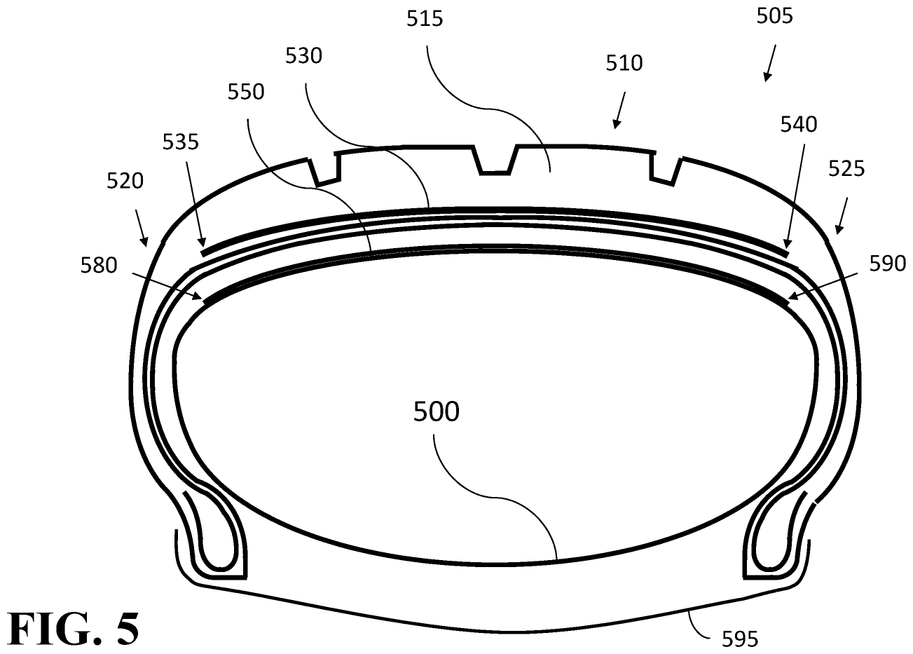

FIG. 5 illustrates a sectional view of a wheel system 505. Wheel system 505 may include an inner tube 500, a tire 510, a liner 550, and a wheel 595. Tire 510 may be mounted to wheel 595. The manner in which tire 510 is mounted to wheel 595 is not limited and may include any manner in which a tire may be mounted to a wheel. Inner tube 500 may be installed in wheel system 505 between a radially outer surface of wheel 595 and a radially inner surface of tire 510.

Inner tube 500 may have an inner surface and an outer surface. Inner tube 500 may have a toroidal shape. Inner tube 500 may have an axial tube width TW (not shown). Inner tube 500 may have a cross section that is either circular or elliptical when inner tube 500 is inflated. Inner tube 500 may have a centerline TC (not shown) oriented on the radial outer surface of inner tube 500. Centerline TC may be centered on the radial outer surface of inner tube 500 such that centerline TC is spaced an equal distance from each of a first axial edge (not shown) and a second axial edge (not shown) of inner tube 500.

Tire 510 may have a tread portion 515 oriented axially between a first shoulder portion 520 and a second shoulder portion 525. Tire 510 may include at least one belt 530 having a first belt edge 535 and a second belt edge 540. The at least one belt 530 may be oriented radially outward from a carcass portion (not shown) having at least one body ply (not shown). The at least one belt 530 may provide circumferential reinforcement for tire 510, while the at least one body ply may provide radial reinforcement for tire 510. Tire 510 may have additional features not shown.

In one embodiment, tire 510 may be a bias ply pneumatic tire. In one embodiment, tire 510 may be a radial pneumatic tire. In one embodiment, tire 510 may be, without limitation, a passenger tire, a light truck tire, a bus tire, a truck tire, an agricultural tire, an off-road tire, a motorcycle tire, a trailer tire, and the like. In one embodiment, tire 510 may be a runflat tire. In one embodiment, tire 510 may be a self-sealing tire. In one embodiment, tire 510 may be a self-inflating tire. Tire 510 may be any tire and is not particularly limited.

Liner 550 may be a flexible liner. Liner 550 may be a puncture resistant liner. Liner 550 may be a puncture resistant and flexible liner. Liner 550 may be a substantially puncture resistant and flexible liner.

Liner 550 may be formed as a rectangle (not shown). Liner 550 may be formed into a loop by abutting or overlapping opposing ends of the rectangle. The abutting or overlapping opposing ends of the rectangle may be attached or unattached to one another. The rectangle may have a width corresponding to an axial width LW (not shown) of liner 550. The rectangle may have a length corresponding to the circumference of liner 550. The rectangle may have a length that is greater than the circumference of liner 550 in order to allow the opposing ends of liner 550 to overlap when formed into a loop.

Liner 550 may be formed as a continuous loop. Liner 550 may have radially opposing surfaces. Liner 550 may have a radially inner surface (not shown) and a radially outer surface (not shown). Liner 550 may have axially opposing edges. Liner 550 may have a first edge 580 and a second edge 590. Liner 550 may have a centerline LC (not shown) on the radial outer surface and/or on the radial inner surface of liner 550 such that centerline LC is spaced an equal distance from each of first edge 580 and second edge 590.

Liner 550 may be oriented axially between first belt edge 535 and second belt edge 540. Liner 550 may be oriented such that first edge 580 is oriented axially inward of first belt edge 535. Liner 550 may be oriented such that second edge 590 is oriented axially inward of second belt edge 540. Liner 550 may be oriented such that first edge 580 is oriented axially inward of first belt edge 535 and second edge 590 is oriented axially inward of second belt edge 540.

Liner 550 may be made from a fiber reinforcement. The fiber reinforcement may be at least one of: a unidirectional fabric, a woven fabric, and a knitted fabric. The fiber reinforcement may have any orientation of fibers that provides for a mesh structure that allows for both open space and movement among adjacent fibers. The fiber reinforcement may be selected for at least one of: its strength, its durability, its flexibility, its weight, its density, its adhesion to other materials, its puncture resistance, and the like.

The puncture resistance of liner 550 may be provided by a fiber reinforcement having a mesh structure of adjacent fibers that are sufficiently close to one another so as to prevent a foreign object from penetrating the mesh structure. The flexibility of liner 550 may be provided by a fiber reinforcement having a mesh structure of adjacent fibers that are sufficiently free to allow movement among one another.

The fiber reinforcement of liner 550 may be used to reinforce another material, such as a polymer. Suitable polymers may include elastomers, such as but not limited to, natural rubbers, synthetic rubbers, and thermoplastic elastomers. The material reinforced by the fiber reinforcement is not limited and may be selected from any material depending upon the needs of the application in accordance with contemporary design, engineering, materials science principles, and the like. The fiber reinforcement may be used to reinforce any material suitable for use in an inner tube or in a tire.

In one embodiment, liner 550 may be a substantially puncture resistant and flexible liner. Liner 550 may be made from a fiber reinforcement selected for its flexibility and/or its puncture resistance. Liner 550 may be made from a fiber reinforcement having a mesh structure that is sufficiently open to allow the material it reinforces to properly adhere to the mesh structure, while simultaneously being sufficiently closed to prevent objects from penetrating the mesh structure.

Liner 550 may have the same material properties, including warp adhesion, weight, material type, ends per in./cm., picks per in./cm., fiber gauge, shrinkage, weight/mass per area, and tensile strength, as liner 250 described above with respect to FIG. 2.

In one embodiment, liner 550 may be operatively connected to inner tube 500. In one embodiment, inner tube 500 may installed within a cavity formed between the radially outer surface of the wheel and the radial inner surface of tire 510. In one embodiment, liner 550 may be oriented radially inward of tread portion 515. In one embodiment, liner 550 may be oriented axially between first shoulder portion 520 and second shoulder portion 525. In one embodiment, liner 550 may be oriented radially inward of tread portion 515 and axially between first shoulder portion 520 and second shoulder portion 525.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available in tire manufacturing, which in one embodiment is ±6.35 millimeters (±0.25 inches). To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

What is claimed is:

1. An inner tube for a pneumatic tire, comprising:
a substantially airtight and flexible toroidal tube having an axial width TW,
wherein the tube has a cross-section that is either circular or elliptical when inflated,
wherein the tube has a centerline TC oriented circumferentially on a radially outer surface of the tube; and
a substantially puncture-resistant and flexible liner having a first edge and a second edge,
wherein the liner is formed in a continuous loop and is operatively connected to the radially outer surface of the tube,
wherein a distance D1 measured from the centerline TC of the tube to the first edge of the liner is between about 10% and about 50% of the axial width TW of the tube,
wherein a distance D2 measured from the centerline TC of the tube to the second edge of the liner is between about 10% and about 50% of the axial width TW of the tube, and
wherein the liner includes a fiber reinforcement comprising a fiber having a weight greater than 15 denier.

2. The pneumatic tire of claim 1, wherein the distance D1 measured from the centerline TC of the tube to the first edge of the liner is between about 20% and about 45% of the axial width TW of the tube, and
wherein a distance D2 measured from the centerline TC of the tube to the second edge of the liner is between about 20% and about 45% of the axial width TW of the tube.

3. The pneumatic tire of claim 1, wherein the liner further comprises a centerline LC, and
wherein the centerline LC of the liner is oriented in substantially the same radial plane as the centerline TC of the tube.

4. The pneumatic tire of claim 1, wherein the tube includes at least one of: a butyl rubber, a latex rubber, and a thermoplastic polymer; and
wherein the fiber reinforcement comprises either a nylon fiber or an aramid fiber.

5. The pneumatic tire of claim 1, wherein the fiber reinforcement comprises a fiber having a weight between about 500 denier and about 1500 denier.

6. The pneumatic tire of claim 4, wherein the liner is operatively connected to the tube by at least one of: an adhesive composition, a double-sided adhesive tape, a vulcanization bond, and an interference fit.

7. An inner tube for a pneumatic tire, comprising:
a substantially airtight and flexible toroidal tube having an axial width TW,
wherein the tube has a cross-section that is either circular or elliptical when inflated,
wherein the tube has a centerline TC oriented circumferentially on a radially outer surface of the tube; and
a substantially puncture-resistant and flexible liner having an axial width LW,
wherein the liner is formed in a continuous loop and is operatively connected to the radially outer surface of the tube,
wherein the axial width LW of the liner is at least one of:
between about 15% and about 40% of the circumference of the tube when the tube is uninflated, and
between about 15% and about 35% of the circumference of the tube when the tube is inflated; and
wherein the liner includes a fiber reinforcement comprising a fiber having a weight greater than 15 denier.

8. The pneumatic tire of claim 7, wherein the axial width LW of the liner is at least one of:
between about 20% and about 35% of the circumference of the tube when the tube is uninflated, and
between about 20% and about 30% of the circumference of the tube when the tube is inflated.

9. The pneumatic tire of claim 7, wherein the liner further comprises a centerline LC, and
wherein the centerline LC of the liner is oriented in substantially the same radial plane as the centerline TC of the tube.

10. The pneumatic tire of claim 7, wherein the tube includes at least one of: a butyl rubber, a latex rubber, and a thermoplastic polymer; and
wherein the fiber reinforcement comprises either a nylon fiber or an aramid fiber.

11. The pneumatic tire of claim 7, wherein the fiber reinforcement comprises a fiber having a weight between about 500 denier and about 1500 denier.

12. The pneumatic tire of claim 7, wherein the liner is operatively connected to the tube by at least one of: an adhesive composition, a double-sided adhesive tape, a vulcanization bond, and an interference fit.

13. A wheel system, comprising:
a wheel;
a pneumatic tire mounted to the wheel,
wherein the tire comprises a tread portion oriented axially between a first shoulder portion and a second shoulder portion;
an inner tube installed within a cavity formed between a radially outer surface of the wheel and a radially inner surface of the tire,
wherein the inner tube comprises:
a substantially airtight and flexible toroidal tube having a cross-section that is either circular or elliptical when inflated; and
a substantially puncture-resistant and flexible liner formed in a continuous loop and operatively connected to a radially outer surface of the tube,
wherein the liner is oriented radially inward of the tread portion and axially between the first shoulder portion and the second shoulder portion, and
wherein the liner includes a fiber reinforcement comprising a fiber having a weight greater than 15 denier.

14. The wheel system of claim 13, wherein the pneumatic tire is at least one of: a bias ply tire, a radial tire, a passenger tire, a light truck tire, a bus tire, a truck tire, an agricultural tire, an off-road tire, a motorcycle tire, a trailer tire, a runflat tire, a self-sealing tire, and a self-inflating tire.

15. The wheel system of claim 13, wherein the tire is not a runflat tire.

16. The wheel system of claim 13, further comprising at least one belt oriented radially outward from a carcass portion of the tire and radially inward from the tread portion,
wherein the at least one belt has a first belt edge and a second belt edge,
wherein the at least one belt provides circumferential reinforcement for tire, and
wherein the liner is oriented axially inward of the first belt edge and the second belt edge.

17. The wheel system of claim 13, wherein the liner further comprises a centerline LC;
wherein the tube further comprises a centerline TC oriented circumferentially on a radially outer surface of the tube; and
wherein the centerline LC of the liner is oriented in substantially the same radial plane as the centerline TC of the tube.

18. The wheel system of claim 13, wherein the tube includes at least one of: a butyl rubber, a latex rubber, and a thermoplastic polymer; and
wherein the fiber reinforcement comprises either a nylon fiber or an aramid fiber.

19. The wheel system of claim 13, wherein the fiber reinforcement comprises a fiber having a weight between about 500 denier and about 1500 denier.

20. The wheel system of claim 13, wherein the liner is operatively connected to the tube by at least one of: an adhesive composition, a double-sided adhesive tape, a vulcanization bond, and an interference fit.
